(19) United States
(12) Patent Application Publication
(10) Pub. No.: US 2015/0180296 A1
(43) Pub. Date: Jun. 25, 2015

(54) Winding for a stator element of an electromagnetic motor or generator, comprising at least one single-component, rigid limb, and method for producing same

(71) Applicant: WHYLOT SAS, CAMBES (FR)

(72) Inventors: Romain Ravaud, Corn (FR); Robert Gaiani, Figeac (FR)

(21) Appl. No.: 14/413,981

(22) PCT Filed: Jul. 18, 2013
(86) PCT No.: PCT/FR2013/000197

§ 371 Date: Jan. 9, 2015

(30) Foreign Application Priority Data
Jul. 25, 2012 (FR) FR 1257220
Nov. 23, 2012 (FR) FR 1203208

(51) Int. Cl. H02K 3/12; H02K 15/03; H02K 5/12

(52) U.S. Cl. CPC H02K 3/12; H02K 5/12; H02K 15/03

(57) ABSTRACT

The present invention relates to a winding (1) for a stator element of an electromagnetic motor or generator, and to the method for producing it. This winding (1) comprises at least two interwoven conductive limbs (10, 10′, 10″) each corresponding to a phase of an electric current, at least one limb (10, 10′, 10″) of the winding being rigid and a in single component.

The invention also relates to a permanent-magnet electromagnetic motor or generator comprising such a winding (1). Such a motor or generator is preferably, but non-limitingly applicable under non-ambient temperature or pressure conditions.

The invention also relates to a method for producing such a winding (1) from a blank of at least one material by material removal or by casting in a mold of at least one component material for each of the limbs (10, 10′, 10″).

This application claims the benefit of United States Non-Provisional Application of WHYLOT, International application number PCT/FR2013/000197, filed 18 Jul. 2013, having the title for WINDING FOR A STATOR ELEMENT OF AN ELECTROMAGNETIC MOTOR OR GENERATOR COMPRISING AT LEAST ONE SINGLE-COMPONENT, RIGID LIMB, AND METHOD OF PRODUCING SAME, which is incorporated herein by reference in its entirety.

The present application benefits from the priority of French patent application FR/1257220 with filing date Jul. 18, 2012.

### TECHNICAL FIELD

The present invention relates to a winding for a stator element of a permanent-magnet motor or generator with at least one single-component rigid limb. It also relates to a permanent-magnet electromagnetic motor or generator comprising a rotor and a stator provided with such a winding. It lastly relates to a method for manufacturing such a winding.

The field of the invention is more particularly, but not limitingly, that of permanent-magnet electromagnetic motors or generators.

### BACKGROUND OF THE INVENTION

Permanent-magnet electromagnetic motors or generators are known in the prior art, in particular brushless motors. These motors or generators, also called synchronous motors, have a rotor supporting one or more permanent magnets and a stator equipped with a winding.

The winding can be broken down into as many limbs as there are electric current phases used to operate the motor. It is also possible to provide several limbs for a same phase of the current.

According to the state of the art, such a winding is generally made by multiple coils of a bundle of conductors that are superimposed on one another. One such winding is described in document FR-A-2 808 936. One drawback of such a winding is that it is time-consuming and tedious to perform, since it is necessary to wind a long length of conductive wire, while ensuring good balancing of the ohmic resistances associated with each phase of the electric current used.

In particular, it is necessary to master the values of the winding sections for example to ensure that the winding sections associated with each phase are equal to each other. Furthermore, it is difficult to thus produce a winding such that the magnetic fields to which a stator is subjected in a permanent-magnet motor are balanced.

Document U.S. Pat. No. 4,319,152 shows a winding comprising at least two interwoven conductive limbs each corresponding to a phase of the electric current, each of the limbs being rigid and in a single component, each of the limbs being formed by slots, each slot comprising an apex framed by at least one lateral segment at each of its ends and a base connecting the slot to an adjacent slot of the limb, each lateral segment connecting an end part of the apex to an end part of the base.

Although this document allows a partial simplification of the manufacture of a winding relative to a winding with multiple coils of a bundle of conductors that are superimposed on each other, such a winding does not allow balancing of the magnetic fields to which a stator is subjected in a permanent-magnet motor with such positioning of the limbs of the winding relative to each other.

One aim of the present invention is to resolve the drawbacks of the known windings for a stator element of a permanent-magnet electromagnetic motor or generator.

In particular, one aim of the present invention is to propose a winding for a stator or rotor element of a permanent-magnet electromagnetic motor or generator that is easy to manufacture and makes it possible to achieve good balancing of the magnetic fields to which a stator element is subjected in a permanent-magnet electromagnetic motor or generator comprising such a winding.

### BRIEF DESCRIPTION OF THE INVENTION

This aim is achieved with a method for manufacturing a winding for a stator element of a permanent-magnet electromagnetic motor or generator, the winding comprising at least two interwoven conductive limbs each corresponding to a phase of an electric current, characterized in that said at least two limbs are rigid and made from the same blank of at least one material by material removal.

Advantageously, the method is done by digitally-controlled machining or electro-erosion.

The invention also relates to a winding comprising at least two interwoven conductive limbs each corresponding to a phase of an electric current, each of the limbs being rigid and in a single component, the winding being obtained according to such a method, each of the limbs being formed by slots, each slot comprising an apex framed by at least one lateral segment at each of its ends and a base connecting the slot to an adjacent slot of the limb, each lateral segment connecting an end part of the apex to an end part of the base, characterized in that the apices of the slots of the first limb are at a higher level on the winding than the apices of the slots of the second limb with a radial angular offset between the slots of one limb relative to the other, the bases of the slots of the first limb being at a lower level on the winding than that of the bases of the slots of the second limb, all of the slots forming the body of the limb.

“Conductive limb” refers to a limb made from an electrically conductive material such as aluminum, copper, silver, or any other material with good electrical conductivity.

“Single-component massive body” means that the limb of the winding has a main body made in a single piece not comprising any internal connecting means, for example gluing or welding. However, auxiliary elements may advantageously be added on this massive body, such as auxiliary lateral segments of a slot for a series of slots forming the limb, said auxiliary lateral segment(s) being electrically in parallel with a lateral segment that is an integral part of the body of the limb.

Thus, it is easily possible to control the section of the winding at each of its points, in particular on all of the winding portions that work magnetically. It is thus possible to master a surface length of the winding (ratio between the length and the section of the winding segment), in particular over all of the winding portions that will work magnetically. In this way, the ohmic resistance of each phase can be balanced, in particular over all of the winding portions that will work magnetically.

Furthermore, it is easily possible to produce a winding such that a permanent-magnet electromagnetic motor or generator element (said element comprising the permanent magnets) undergoes balanced magnetic fields. A winding is made using a single conductor rather than a bundle of conductors. This can for example make it possible to reduce the ohmic resistance of the winding.

Furthermore, making winding limbs in the same mass piece improves its mechanical strength. The entire winding is rigid and in a single component while having a massive body shared by all of the limbs.

Different lateral segments are at the same distance from permanent magnets with which the winding can cooperate in an electromagnetic motor or generator. Thus, the different phases associated with different limbs of the winding create magnetic fields with the same absolute value for said permanent magnets.

Advantageously, the winding comprises n single-component rigid limbs, with x greater than 1 and less than n, the apex of the x^{th} limb of the n limbs being at a level higher than that of the apex of the x+1^{st} limb and at a level lower than that of the apex of the x−1^{st} limb, the base of the x^{th} limb being at a lower level than the base of the x−1^{st} limb and a higher level than the base of the x+1^{st} limb.

Advantageously, each apex of said at least one second limb or each base of the first limb has a notch for the passage of a lateral segment of a slot of the first limb or, respectively, a lateral segment of a slot of said at least one second limb.

Advantageously, the lateral segments of the slots of the limbs are inclined in the height direction of the winding toward the associated base of the slots.

Advantageously, the lateral segments of the slots of the limbs are positioned in the same plane as the associated apex of the slots, a level difference being provided on each end of the base for its connection with the opposite end of the associated lateral segment.

Advantageously, at least for one slot, at least one auxiliary lateral segment is provided connected to the same end of an apex as a lateral segment that is part of the body of the limb. In a conductor, the central part does not conduct current and is therefore useless for conducting electricity. Furthermore, inside the conductor, losses are created by Eddy currents; those losses increase with the section of the conductor. In order to limit energy losses and bulk, it is therefore preferable to have several conductors with a small section in parallel than to have a single conductor with a large section.

Advantageously, said at least one auxiliary lateral segment is rigid and made in a single piece with the body of the limbs supporting it.

In another alternative, said at least one auxiliary lateral segment is connected with its associated apex by a securing means.

Advantageously, the lateral segments associated with a same end have one or more of the following features: different sections, different orientations or different materials.

Advantageously, the winding is formed from three conductive limbs each corresponding to a phase of a three-phase electric current. This embodiment has the advantage of being adapted to a three-phase current, as is generally provided by electricity suppliers.

The invention also relates to a permanent-magnet electromagnetic motor or generator comprising at least one rotor and at least one stator, characterized in that it comprises at least one such winding.

Advantageously, the motor is an axial flux electromagnetic motor or generator, said at least one winding having a cylindrical shape. In another embodiment, the motor or generator may be a radial flux electromagnetic motor or generator, said at least one winding being crown-shaped.

In the case of an axial flux electromagnetic motor or generator, the lateral segments of the slots are then advantageously parallel to each other and situated on the lateral face of the cylinder. In this way, the different lateral segments are at the same distance from permanent magnets with which the winding can cooperate in the electromagnetic motor or generator. Thus, the different phases associated with different limbs of the winding create magnetic fields with the same absolute value for said permanent magnets.

In both cases, the limbs are substantially intercalated such that the lateral segments of each of the limbs periodically follow each other, where one period comprises a sequence of one lateral segment of each limb. The lateral segments are regularly spaced apart from each other, i.e., the interval between two adjacent lateral segments is constant over the entire perimeter of the winding. The slots of the different limbs are therefore offset from each other by a value that in particular depends on the number of limbs.

Advantageously, the stator(s) of the motor or generator comprise a flat ring provided with teeth situated in the plane of the ring facing the associated rotor, at least one winding being interleaved in those teeth.

Advantageously, said at least one winding is molded in an insulating binder, for example an insulating resin, then housed in the stator(s), the rotor having permanent magnets and being made from glass fiber.

Advantageously, the motor or generator according to the invention has a multi-air gap structure. In particular, it may have at least two air gaps, and even at least three. In fact, it is possible to consider complex winding shapes such as shapes required to implement such a multi-air gap structure, in particular with three or more air gaps.

Preferably, the teeth are dimensioned to match the winding, the winding portions passing in the teeth being magnetically active. Advantageously, the stator is formed by foliated magnetic metal sheets.

According to one alternative, the stator receives the winding while being made from a nonmagnetic material. The nonmagnetic material can comprise a plastic, a resin, wood, etc.

There is a tendency to wind the windings on a magnetic material, in order to channel the created magnetic field and thereby provide a motor or an electromagnetic generator having a significant torque. However, this has the drawback of also creating strong energy losses, in particular by Joule effect, and iron losses caused by hysteresis or Eddy currents. The idea at the base of this alternative is to accept a certain torque loss in order to obtain an optimized energy output. According to one particular embodiment, the stator is a dual stator, the two stators each having their own winding and framing the rotor.

The torque offered by the motor or generator according to the invention can thus be doubled.

The rotor(s) can comprise permanent magnets fastened in a composite material, such as a glass fiber-based composite material. One advantage of a rotor made from composite material is that it is light, typically five times lighter than steel. A rotor is thus produced having less inertia. It is possible to produce greater accelerations using such a rotor. The composite material is advantageously a material not conducting electricity, such as a glass fiber-based composite material.

The advantage of a rotor made from a material not conducting electricity is that it eliminates losses that may occur through the appearance of parasitic currents in the rotor due to the variable magnetic fields to which it is subjected. These parasitic currents create energy losses. Furthermore, these parasitic currents can oppose the desired effects created by the electrical currents that pass through the windings.

The composite material can comprise oriented fibers with several spatial orientations. One advantage of a fibrous composite material is that it has excellent mechanical strength. It is therefore possible to achieve high rotational speeds of the rotor risk-free. Furthermore, this mechanical strength can be improved owing to the fastening of the permanent magnets on the rotor by reinforcements.

The invention also relates to the use of such a motor or generator, characterized in that it is done in combination with a closed enclosure, the motor or generator being placed inside or outside the enclosure, the motor or generator being under vacuum or a pressure greater than 2 bars or at a temperature below 0° C. or above 60° C. The motor or generator is then used to regulate the temperature and/or pressure inside the closed enclosure.

It has in fact been observed that a motor or generator with at least one such winding was very strong under non-ambient operating conditions. Non-limitingly, this for example allows the motor or generator to be used in combination with closed spaces under pressure or high temperature, for example a furnace, and in particular a quenching cell. This increases the possibilities for using permanent-magnet motors or generators.

### DESCRIPTION OF THE FIGURES AND EMBODIMENTS

Other advantages and specificities of the invention will appear upon reading the following detailed description of non-limiting implementations and embodiments, and the following appended drawings:

FIG. 1 illustrates a perspective view of a first winding embodiment according to the invention, adapted to an axial flux electromagnetic motor or generator,

FIG. 2 illustrates a detailed view of the winding shown in FIG. 1, the winding being formed by three interwoven limbs, each limb comprising a series of slots with an apex, a lateral segment of each side of the apex and base connecting one slot with an adjacent slot,

FIG. 2a illustrates a detailed view of another embodiment of the winding shown in FIG. 2, one slot comprising several lateral segments on each side of an apex,

FIG. 3 illustrates a perspective view of a support for the winding shown in FIG. 1, forming a stator with said winding for an axial flux electromagnetic motor or generator,

FIG. 4 shows a perspective view of a stator comprising the support shown in FIG. 3 and on which the winding shown in FIG. 1 is interleaved,

FIG. 5 shows a cross-sectional view of the axial flux electromagnetic motor or generator comprising a double stator, each stator corresponding to the stator as shown in FIG. 4,

FIG. 6 illustrates a view of half of a rotor of the electromagnetic motor or generator shown in FIG. 5,

FIG. 7 illustrates a perspective view of a limb of a second winding embodiment according to the invention, adapted to a radial flux electromagnetic generator or motor,

FIG. 8 illustrates the principle of a rotor of a radial flux electromagnetic motor or generator according to the invention,

FIG. 9 illustrates a perspective view of a limb of one embodiment of the winding similar to that shown in FIG. 2a, one slot comprising several lateral segments on each side of an apex, and

FIG. 10 illustrates a perspective view of a limb of one embodiment of the winding similar to that shown in FIG. 2.

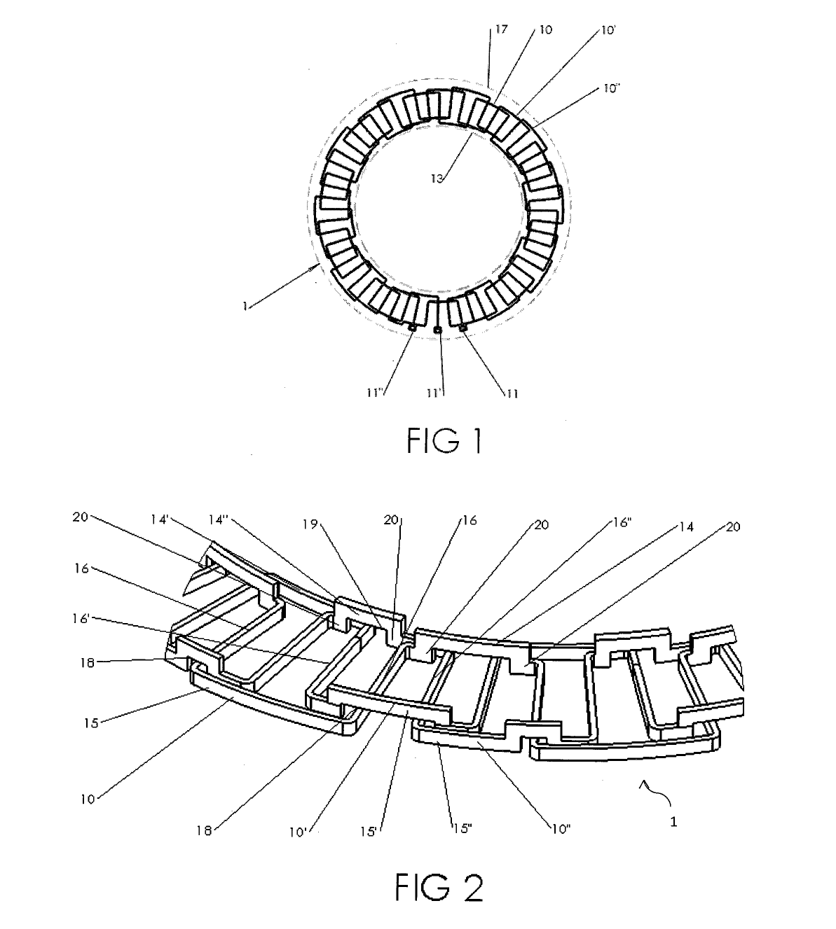

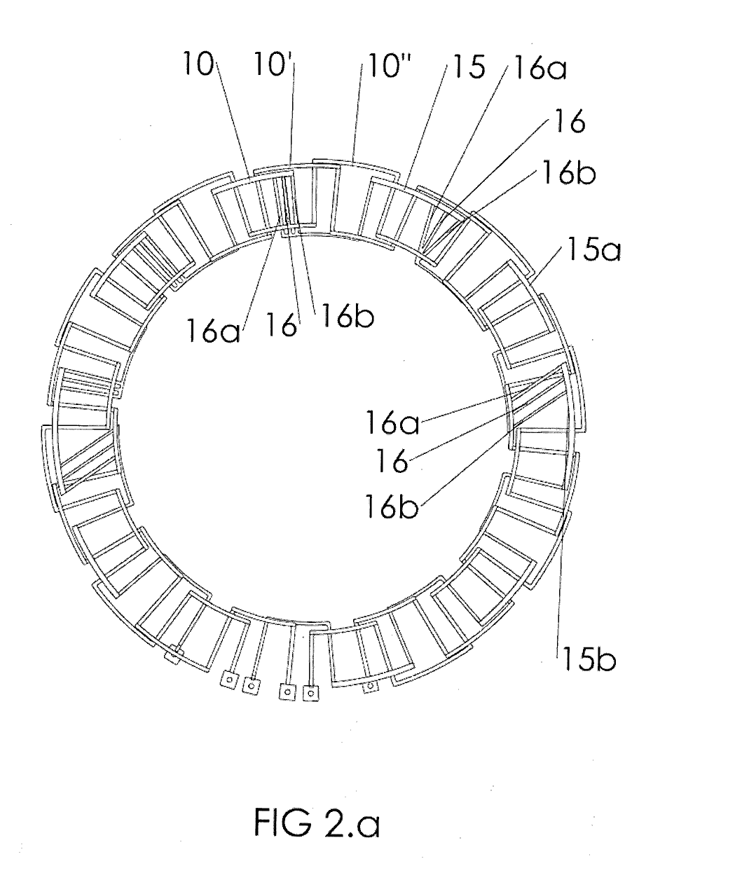

In the rest of this document, an element in the foreground of the figure in question will be described as an upper element, and the opposite for elements in the background. This is particularly valid for FIGS. 1, 2 and 2a.

In reference to FIG. 1, we will first describe a first embodiment of a winding 1 according to the invention. In the rest of the document and in the interest of concision, the term “electromagnetic motor or generator” will be used, rather than “permanent-magnet electromagnetic motor or generator”.

The winding 1 comprises three electrically conductive limbs 10, 10′ and 10″. Each limb can correspond to one phase of a three-phase current. The three phases are connected to each other in a so-called “star” assembly (one shared point of contact for all three phases). Each limb 10, 10′, 10″ has an associated connector 11, 11′, 11″, respectively. Another assembly is also possible.

All of the limbs 10, 10′, 10″ of the winding 1 are rigid and made from a same blank by material removal of at least one component material of said limbs. This blank can advantageously be made up of multiple layers that are superimposed or may contain areas made from different materials.

The material removal can be done in various ways, in particular by bulk machining, for example by digital control, and a blank made up of a massive block of a metal conductor such as a copper or aluminum disc. It is also possible to perform electro-erosion of such a block, also advantageously by digital control.

“Single component” means that the body of the limb 10, 10′, 10″ does not comprise only several parts wound on each other or attached by any connecting means. All of the limbs 10, 10′, 10″ of the winding are part of the same single-component rigid main body, all of its limbs coming from a same blank.

The blank formed by a massive block may, however, comprise layers of different materials connected to each other, for example in order to obtain limbs 10, 10′ and 10″ made from a different material or even different materials for a same limb 10, 10′, 10″.

A winding 1 that is at least partially rigid is thus produced, where all of the limbs 10, 10′ and 10″ come from a same single-component blank, without there being any need for welding, the winding 1 having a massive body.

It is also possible to provide for making the complete winding by bulk machining, the winding comprising the different limbs connected to each other at a point of contact in the star assembly. It is also possible to provide that the different limbs have no contact, in particular electrical contact, with any other limb. It is also possible to provide that the different limbs are connected to each other in a so-called “triangle” assembly.

The limbs may be interleaved with each other in the desired manner for operation of the electromagnetic motor or generator that one is seeking to make after their respective machining operations. However, the limbs of the winding are machined at the same time in a same massive block.

The winding 1 shown in FIG. 1 is adapted to an axial flux electromagnetic motor or generator. It is in the form of a circular blank with an open center, or a crown. Each limb 10, 10′ and 10″ forms slots. There may be any number of slots on a limb 10, 10′, 10″.

The assembly formed by the slots of a limb 10, 10′, 10″ defines a single-component rigid body. FIG. 1 shows limbs 10, 10′ and 10″ each formed by such a body, but in other embodiments, in particular that shown in FIG. 2a, the body can receive one or more auxiliary lateral elements, in particular in the form of one or more lateral segments. This embodiment will be explained later in light of FIG. 2a.

FIG. 2 illustrates a detailed view of the winding shown in FIG. 1. For each respective limb 10, 10′, 10″, there is a differentiation between the base 14, 14′, 14″ of a slot, the apex 15, 15′, 15″ of the slot and at least two lateral segments 16, 16′, 16″. A lateral segment 16, 16′, 16″ is therefore positioned on each side of the apex 15, 15′, 15″ while framing said apex 15, 15′, 15″ by forming an angle therewith, advantageously but non-limitingly a right angle. Two lateral segments 16, 16′, 16″ associated with a same slot on either side of the apex 15, 15′, 15″ are said to be reversed, each being chiral relative to the other associated segment.

In the embodiment shown in FIG. 2, for each limb 10, 10′, 10″, the apex 15, 15′, 15″ and the lateral segments 16, 16′, 16″ of a same limb 10, 10′, 10″ are comprised in a same plane, those planes being superimposed. Still in this embodiment, the lateral segments 16, 16′, 16″ are substantially parallel. It should, however, be considered that for a same limb 10, 10′, 10″, the lateral segments 16, 16′, 16″ may not be parallel or may not be incorporated into a same plane as the apices 15, 15′, 15″ of the same limb 10, 10′, 10″.

The base 14, 14′, 14″ of a slot of a limb 10, 10′, 10″ connects it with the slot of the same limb 10, 10′, 10″ that is directly adjacent to it on that side. The apices 15, 15′, 15″ of the limbs 10, 10′, 10″ are not strictly superimposed, but offset over the perimeter of the winding in planes or levels with different heights in the winding. In the rest of the document, an element at a higher level than another element is located in a plane above the plane of the other element, but not necessarily directly superimposed on that other element. The same is true for the lower level.

The assembly of the apex 15 and lateral segments 16 of a first limb 10 forms the upper part of the winding 1, the other two limbs 10′, 10″ then being located below the first limb 10, the slots that they respectively form being offset over the perimeter of the winding 1. The assembly of apices 15 and associated lateral segments 16 of the first limb 10 is therefore at a higher level than the assemblies of apices 15′, 15″ and lateral segments 16′, 16″ of the other two limbs 10′, 10″.

The bases 14 of the slots of the first limb 10 are at a lower level than the bases 14′, 14″ of the second and third limbs 10′, 10″. In this configuration, the second limb 10′ is the intermediate limb, while having its assemblies of apices 15′ and lateral segments 16′ at a higher level than the assemblies of apices 15″ and lateral segments 16″ of the third limb 10″.

This embodiment therefore provides a level difference 20 supported by the ends of the base 14, 14′ between the end of the lateral segments 16, 16′ of the first and second limbs 10, 10′ and the associated base 14, 14′, that level difference making it possible to bring the limb 10, 10′ to a lower level on the winding 1. In another embodiment, it is the lateral segments 16, 16′ that are oriented toward the bottom of the winding 1 while being inclined accordingly and which form the level difference to take the limb 10, 10′ to a lower level on the winding 1.

Each lateral segment 16 of a slot of the first limb 10 extends passing through a respective apex 15′ of the second limb 10′ or intermediate limb, via a notch 18 formed in said apex 15′ so as to free a passage space for said segment 16.

The same is true for each lateral segment 16′ of the intermediate limb 10′ passing through a notch 18 formed in an apex 15″ of the third limb 10″ or lower limb. This notch 18 also serves as a passage for a lateral segment 16 of the first limb 10, the lateral segment 16 of the first limb 10 being a reverse lateral segment relative to the lateral segment 16′ of the second limb 10′.

The base 14 of each slot of the first limb 10 is at a lower level than the slots of the second intermediate limb 10′ and the third lower limb 10″. Each base 14 of the first limb 10 also comprises a wide enough notch 19 to allow the passage of a lateral segment 16′ of the second limb 10′ and a lateral segment 16″ of the third limb 10″. In that case, the lateral segment 16′ of the second limb 10′ is a reverse lateral segment relative to the lateral segment 16″ of the third limb 10″.

The notches 18 and 19 are formed by material removal in the length of the apex 15′, 15″ or the base 14 supporting it, respectively, that material removal having a depth over a portion of the width of the apex 15′, 15″ or the respective base 14 while leaving material on that width making it possible not to form an interruption for that apex 15′, 15″ or that base 14. The notches 18 and 19 may for example be 2 mm.

There is therefore interweaving between the first, second and third limbs 10, 10′, 10″ of the winding 1. In general, the winding 1 can comprise n single-component rigid limbs 10, 10′, 10″, and not only three limbs as shown in FIG. 2.

With x comprised between 1 and n while being greater than 1 and less than n, the apex 15′, 15″ of the x^{th} limb 10′, 10″ is at a level higher than that of the apex of the x+1^{st} limb and a level lower than that of the apex of the x−1^{st} limb, the base 14′, 14″ of the x^{th} limb being at a lower level than the base of the x−1^{st} limb and at a higher level than the base of the x+1^{st} limb.

For example, the apex 15 of the first limb 10 is at a higher level than that of the apices 15′, 15″ of the n−1 remaining limbs 10′, 10″ and its base 14 is at a lower level than that of the bases 14′, 14″ of the remaining n−1 limbs. The apex 15″ of the n^{th} limb 10″ is at a lower level than the apices 15, 15′ of the n−1 remaining limbs 10, 10′ and its base 14″ is at a higher level than the bases 14, 14′ of the remaining n−1 limbs, n being equal to 3 in FIG. 2.

It is also possible to use other forms of interweaving for the limbs 10, 10′, 10″ of the winding 1, provided that each limb 10, 10′, 10″ has parts at a level higher than the other limbs 10, 10′, 10″ and parts at a level lower than the other limbs 10, 10′, 10″, which allows balancing of the magnetic field.

As shown in FIG. 1, the winding 1 fits into an outer crown 17 shown in dotted lines in FIG. 1. The apices 15, 15′, 15″ of the slots outline that outer crown 17. An inner crown 13 is fitted inside the winding 1. The bases 14, 14′, 14″ of the slots outline that inner crown 13.

The lateral segments 16, 16′, 16″ of the slots of a same limb 10, 10′, 10″ are advantageously coplanar. The lateral segments 16, 16′, 16″ are distributed periodically following one another. A period next comprises a lateral segment 16, 16′, 16″ of each of the three limbs 10, 10′ and 10″. The interval between two lateral segments 16, 16′, 16″ is constant. Each lateral segment 16, 16′, 16″ of a limb 10, 10′ or 10″ is comprised between a lateral segment of each of the other two limbs.

FIG. 2a illustrates an embodiment of the winding where at least one limb 10, 10′ and 10″ of the winding has at least one slot with at least one auxiliary lateral segment 16a, 16b, 16c connected to the same end of an apex 15 as a lateral segment 16 that is part of the body of the limb 10.

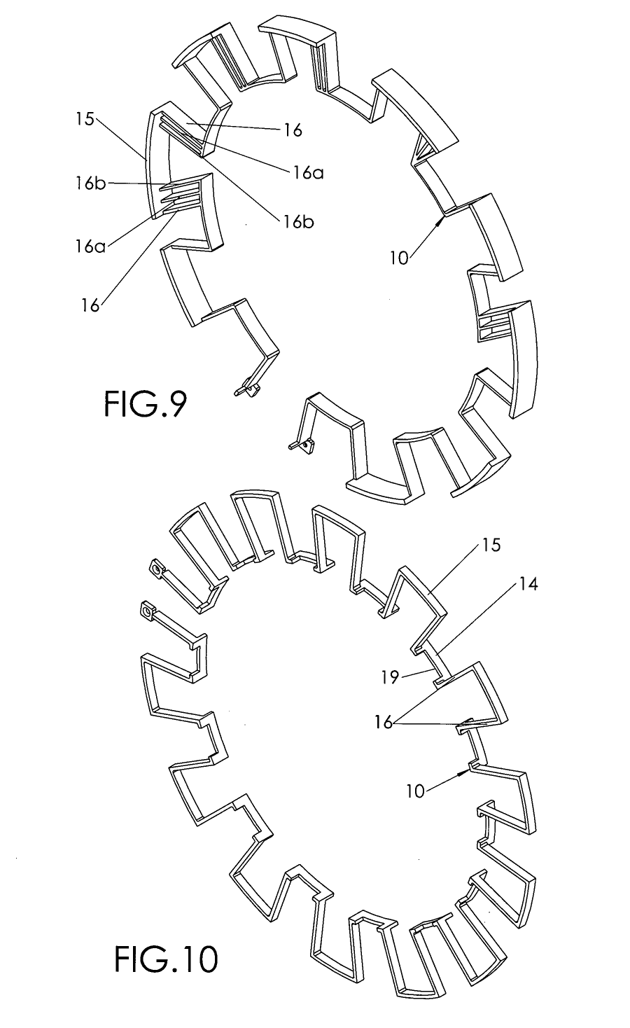

An embodiment similar to that shown in this FIG. 2a can also be seen in FIG. 9, which shows a single winding limb 10 having several auxiliary lateral segments 16a, 16b, 16c in addition to the lateral segment 16 on the same side of an apex 15, while FIG. 10 shows, as a comparison, a single limb 10 of a winding with a single lateral segment 16 on a side of the apex 15.

In reference to FIGS. 2a and 9 in combination, auxiliary lateral segments 16a, 16b, 16c are shown for the first limb 10, called upper limb, and for the second limb 10′, called intermediate limb, only the auxiliary lateral segments 16a, 16b, 16c of the first limb 10 being shown with references for greater clarity in these figures and to avoid needlessly overloading them.

These auxiliary lateral segments 16a, 16b, 16c, which serve primarily to reduce losses by Joule effect in the winding, can, however, be adapted on the n limbs 10, 10′ and 10″ of the winding. These auxiliary lateral segments 16a, 16b, 16c advantageously have a small section, that section being able to be any section, in particular but not limited to square, rectangular or circular.

All of the slots of at least one limb 10, 10′, 10″ can be equipped with auxiliary lateral segments 16a, 16b, 16c, or only one of the slots of a limb 10, 10′ and 10″. Windings may also exist with one or more auxiliary lateral segments 16a, 16b, 16c for a limb 10, 10′ and 10″ and no auxiliary lateral segment 16a, 16b, 16c for another limb 10, 10′ and 10″.

Several embodiments of these auxiliary lateral segments 16a, 16b, 16c are possible. For example, said at least one auxiliary lateral segment 16a, 16b, 16c can be rigid and form a single component with the body of the limb 10 supporting it. In that case, said at least one auxiliary segment 16a, 16b, 16c is advantageously obtained during the method for manufacturing the limb from a blank as part of the body of the single-component rigid limb.

In one alternative, said at least one auxiliary lateral segment 16, 16a, 16b can be connected by connecting means with its associated apex 15. This connecting means can be a weld, a magnetic glue or any mechanical means conducting current.

For these two alternatives, the lateral segments 16, 16a, 16b, 16c, i.e., the auxiliary lateral segments and the segment 16, associated with a same end of an apex 15, 15a of a slot of a limb 10 of the winding have one or more of the following characteristics: different sections, different orientations or different materials.

In FIG. 2a, an apex 15 or 15b is shown associated on one side with three lateral segments 16, 16a, 16b, including two auxiliary lateral segments 16a, 16b. On this side of the apex 15, the three lateral segments 16, 16a, 16b are inclined toward one another to join toward the base of the slot. However, for the apex 15b, the lateral segments 16, 16a, 16b of a same side of the apex 15b are parallel to each other. Another apex 15a has only one lateral segment on each of its sides.

All of this is in no way limiting. For example, a slot of a limb 10, 10′ and 10″ does not necessarily have a different number or incline of the lateral segments 16, 16a, 16b on each of its sides. The number of lateral segments 16, 16a, 16b for a slot can also be any number and is not limited to three or four.

Advantageously but not limitingly, one of the lateral segments 16, 16a, 16b can be made from a different material from the other associated lateral segments 16, 16a, 16b or the material of the apex 15, 15a or 15b. For example, this lateral segment may be an auxiliary lateral segment added by a connecting means after manufacturing the limb 10, 10′ and 10″.

However, it is also possible for this lateral segment to be a lateral segment obtained directly during manufacturing of the limb 10, 10′ and 10″ while being part of the body of the limb 10, 10′ and 10″. In that case, the blank, as a massive part to obtain at least one limb 10, 10′ and 10″ and advantageously to obtain n limbs 10, 10′, 10″ of the winding that are manufactured together, comprises parts made from different materials.

The materials that may be used are materials with good conductivity, advantageously aluminum, copper, tin, silver, etc.

If the massive part to obtain at least one limb 10, 10′ and 10″ or the complete winding undergoes material removal, the areas of that massive part that must correspond to one or more lateral segments of different materials have been predefined, those areas being areas made up of said material different from the base material of the part.

If the limb 10, 10′ and 10″ or the complete winding is manufactured by molding, successive castings are done with different base materials of the limb 10, 10′, 10″ and the winding and that of the lateral segment(s) 16, 16a, 16b in different materials. Parenthetically, FIG. 2a shows a winding with six poles, while in FIG. 2 there were only three poles, due to the different electrical connection, which is not in a star in that figure.

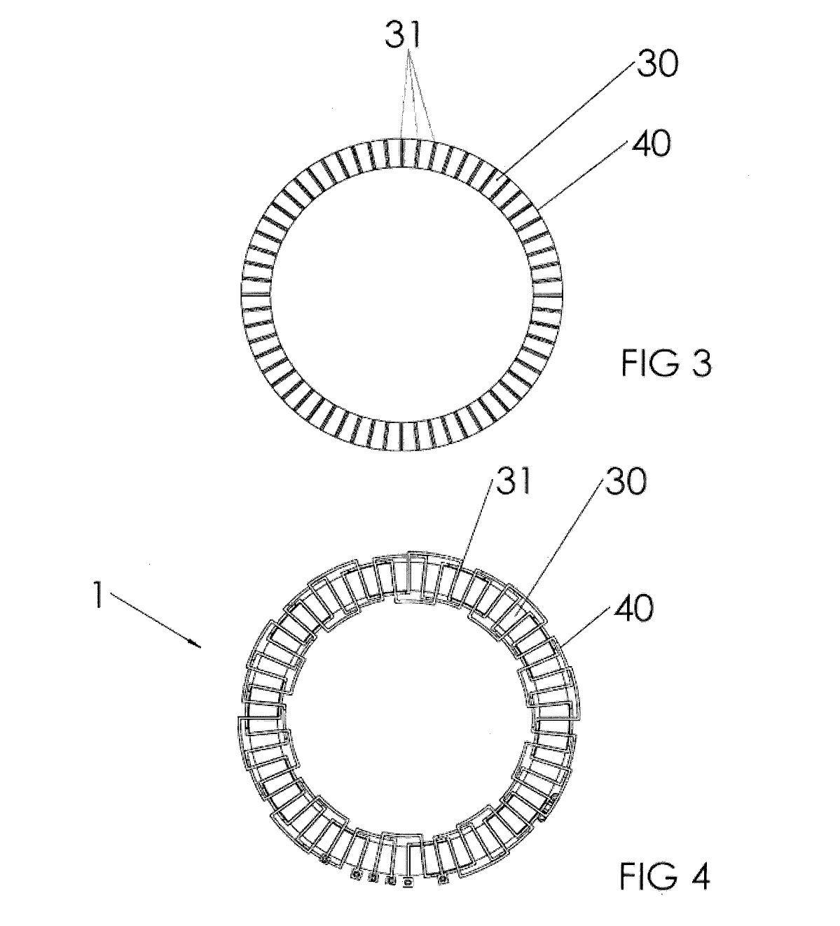

FIG. 3 illustrates a perspective view of a support 30 for the winding shown in FIG. 1, forming a stator 40 with said winding for an axial flux electromagnetic motor or generator. The support 30 is in the form of a solid disc with an open center and provided with radial teeth 31 (i.e., each oriented along a radius of the circular support 30) embedded over part of its thickness. The term “toroid” may also be used to designate the support 30. When there are several lateral segments, there may be as many teeth as there are lateral segments.

The support 30 is formed from magnetic metal sheets (for example iron, nickel or steel) wound on each other, which may be of different natures and thicknesses. These are preferably magnetic metal sheets with non-oriented grains. This may be referred to as a foliated material. The metal sheets are advantageously wound flat around the circular axis of symmetry of the support 30.

FIG. 4 illustrates a perspective view of a stator 40 comprising the support 30 shown in FIG. 3 and on which the winding 1 that is partially received in the teeth 31 is interleaved. Only the parts of the winding passing in the teeth 31, shown in FIGS. 3 and 4, are magnetically active, those parts advantageously being the lateral segments of the slots. The shape of the circumferential winding segments (bases and apices of the slots) is of little importance.

The assembly can next be embedded in an insulating binder, for example a resin, to ensure the electrical insulation thereof. Furthermore, the mechanical stability of the support 30 is also improved relative to the winding. The passage of the current in the winding crossing through the support 30 creates an induced magnetic field.

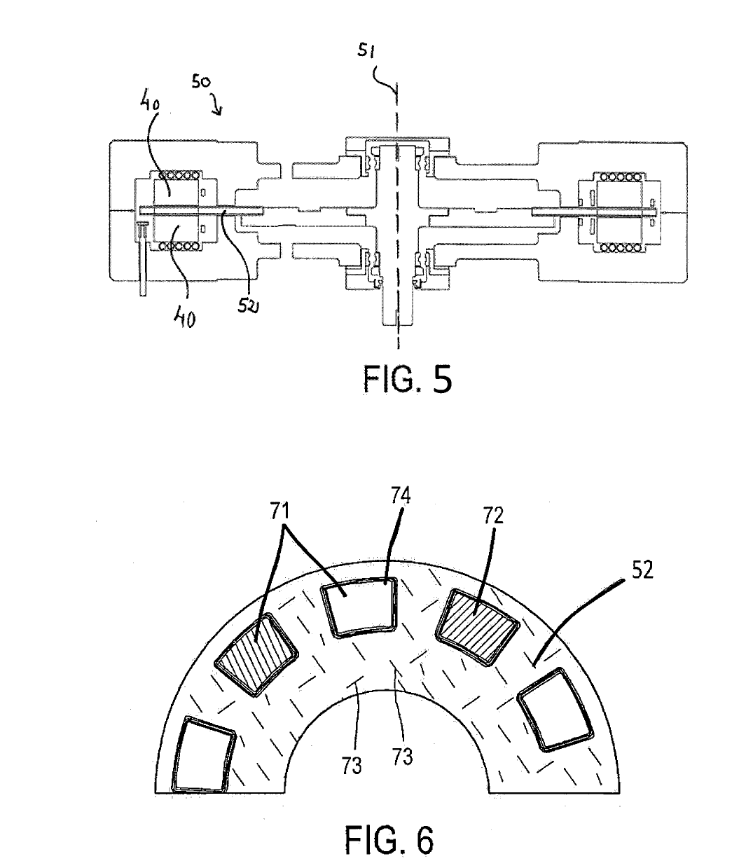

FIG. 5 illustrates a cross-sectional view of an example axial flux electromagnetic motor or generator 50 comprising a dual stator, each stator 40 corresponding to the stator as shown in FIG. 4. Reference may be made to a double-air gap motor. The motor 50 is provided to rotate around an axis of rotation 51.

The axial flux electromagnetic motor or generator 50 shown in FIG. 5 comprises a single rotor 52 placed between two stators 40. Each stator 40 shows the rotor 52 its face provided with the teeth, shown in FIG. 4 under reference 31 and in which the winding according to the invention passes.

It may be provided that, for a given phase, the limbs corresponding to that phase of the two stators 40 are connected in series or in parallel. The limbs of the respective windings of the two stators 40 that correspond to the same phase may be connected together. It is also possible to provide that the windings of the two stators 40 are machined together during machining.

The rotor 52 comprises axial flux permanent magnets, distributed alternating in one direction and then the other on the rotor, across from the winding. On each side of the rotor 52, the north and south poles of the magnets follow each other. By varying the electric current passing through the winding, it is then possible to rotate the rotor 52.

The magnets are in the shape of a thick circular arc. They are said to be in axial flux because the magnetic field is orthogonal to the plane of the arcs of circle. The center of the arcs of circle passes through the axis of rotation of the motor or generator. The permanent magnets are inserted in the holes passing through a composite matrix forming the rotor 52 with the magnets. Each magnet therefore shows its north pole to one of the stators 40 and its south pole to the other stator. Each magnet is fastened by reinforcement in an associated through hole.

In one example embodiment, the four corners of the magnet are in direct contact with the edges of the through hole. Glue placed around those four corners improves the mechanical strength of the magnet in the through hole. The rotor 52 may not include an electrically conductive material, in particular iron. The composite matrix receiving the permanent magnets may comprise glass fiber in its place. In an embodiment derived from FIG. 5, it is also possible to position several rotor 52 and stator 40 assemblies consecutively on the axis of rotation 51, advantageously arranged in the form of a pair as shown in FIG. 5.

FIG. 6 illustrates a front view of half of the rotor 52, i.e., in a plane orthogonal to the axis of rotation 51, the axis being shown in FIG. 5. Permanent magnets 71 can be seen that alternate between showing the stator a north magnetic pole (crosshatched in the figure) and a south magnetic pole (not crosshatched in the figure). Each magnet is housed in a through hole hollowed in a composite matrix having glass fibers 73. The fibers have different spatial orientations. Each magnet 71 is fastened by reinforcement in the composite matrix. The reinforcement (outer part, as opposed to the inner part, which is called reinforced) is formed by winding a lay-up 74 of composite material with a base of glass fibers.

Reference may be made to a flat motor, since it is formed from superimposed discs (or crowns): one rotor between two stators. The air gap faces are situated flat on discs and not on a lateral face of a cylinder. One advantage of this arrangement is that a motor is produced with a double air gap but a single rotor. There is only one rotor to be coupled, which simplifies the coupling. This is a synchronous motor or generator, i.e., consuming or producing electrical current whose frequency determines the speed of rotation of the rotor.

One particular but non-limiting application of the motor or generator according to the present invention is in the field of pressure or temperature ranges below or above ambient pressure or temperature.

For example, in the case of operation at high pressure, i.e., greater than 10 bars, a motor according to the present invention may for example have the following characteristics:

energy efficiency of 95% to 99%

cos φ equal to the unit (the angle φ is called “power factor”. The power factor is the time shift (called “phase shift”) between the voltage and current.)

total weight (rotor, stators, windings, carcass): 150 to 500 kg

rotating mass: 10 to 22 kg

maximum electric current in the winding: 400 to 500 amperes

maximum electric power supply voltage: 400 to 600 Volts

power supplied 200 kW to 350 kW

three-phase power supply

thickness: 130 to 250 mm

diameter 700 to 900 mm.

One very particular application of such a synchronous motor is to make it possible to drive a mixing element in an industrial furnace, for example in the form of a fan or turbine.

In one particularly advantageous use, this motor may be used in a quenching cell for at least one part to be treated, in particular with low cementation, the motor being able to undergo a pressure from 5 to 30 bars and a temperature comprised between 20° C. and 150° C. The motor made thus find itself outside the cell while being in an overpressure relative to the quenching cell. In such a quenching cell, in particular under gas, the mixing element driven by the motor initiates a flow of gas between the treated part and an exchanger placed in said cell.

This allows the use of a synchronous motor associated with a quenching cell, whereas in the prior art, only asynchronous motors were used, one of the drawbacks of asynchronous motors being that they are bulkier and therefore heavier, in addition to being more difficult to start up, with lower rotational speeds and lower efficiency.

As a point of reference, these asynchronous motors may have the following characteristics:

energy efficiency of 60%

cos φ less than or equal to 0.5

total weight: at least 1200 kg

rotating mass: at least 500 kg

dimensions: 1 meter over 0.8 meters, plus a terminal block

supplied power 200 kW.

In general, a motor or generator according to the present invention may be used in combination with a closed enclosure, the motor or generator being placed inside or outside said enclosure, the motor or generator being under vacuum or pressure exceeding 2 bars or at a temperature below 0° C. or above 60° C.

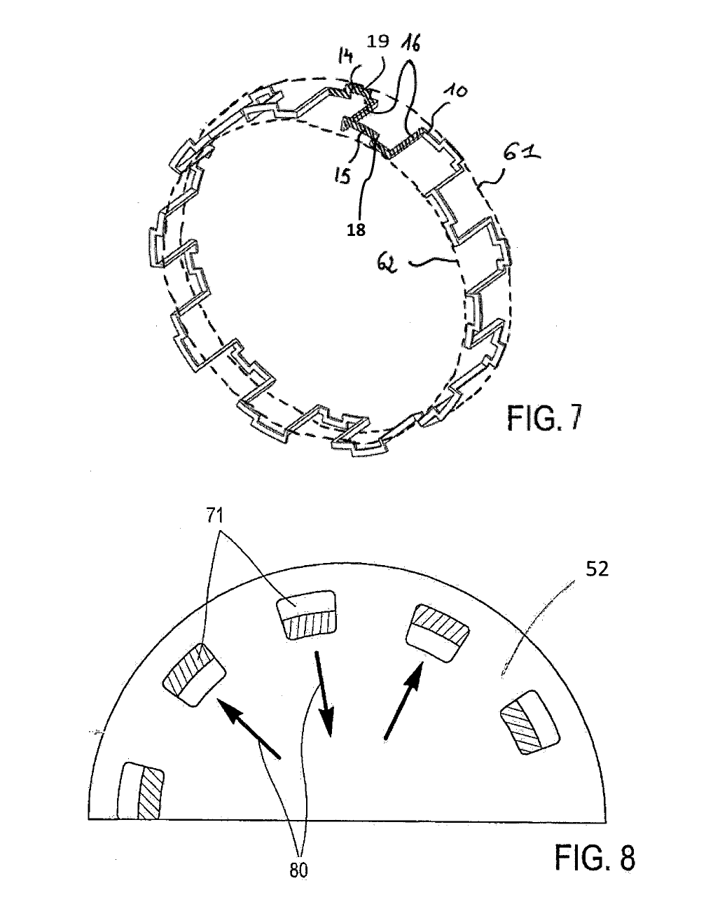

FIG. 7 provides a perspective view of a limb of a second winding embodiment according to the invention, adapted to a radial flux electromagnetic motor or generator. FIG. 7 illustrates a single limb 10 of such a winding, said limb comprising a series of slots each comprising an apex 15, a base 14, the two respective ends of the apex 15 and the base 14 being connected by a lateral segment 16.

In the case of a three-phase power supply, it is necessary to imagine three limbs of the same type. Such a limb can also receive one or more lateral segments from the two sides of an apex of the slot, in particular as illustrated in FIG. 2a. The same considerations set out in light of FIG. 2 for the winding can also apply to this embodiment.

A radial flux electromagnetic motor or generator is for example substantially similar to the axial flux electromagnetic motor or generator described above. The permanent magnets on the rotor are in the form of a thick circular arc. They are said to have a radial flux because the magnetic field converges toward the center of the circular arc. The winding can have a cylindrical shape.

The limb 10 is formed by a band outlining the slots. A slot is shown crosshatched in FIG. 7. The bases 14 of the slots outline a circle 61 forming the base of the cylinder, and the apices 15 of the slots outline a circle 62 forming the apex of the cylinder.

The lateral segments 16 of the slots are parallel to each other and situated on the lateral face of the cylinder. They can advantageously form the magnetically active part of the winding, while being interleaved in corresponding teeth of a stator.

FIG. 8 illustrates the principle of a rotor of such a radial flux electromagnetic motor or generator. The arrows 80 illustrate the direction of the magnetic field created by the permanent magnets 71.

Of course, the invention is not limited to the examples described above, and many developments may be made to these examples without going beyond the scope of the invention. In particular, all of the features, shapes, alternatives and embodiments previously described may be combined with each other in various combinations as long as they are not incompatible or mutually exclusive. It is also possible to provide any combination of one or more rotors and one or more stators. For example, it is possible to provide two permanent-magnet rotors each in the form of rings and framing a stator also in the form of a ring and provided with a winding according to the invention.

1. A method for manufacturing a winding (1) for a stator element of a permanent-magnet electromagnetic motor or generator, the winding comprising at least two interwoven conductive limbs (10, 10′, 10″) each corresponding to a phase of an electric current, characterized in that said at least two limbs (10, 10′, 10″) are rigid and made from the same blank of at least one material by material removal (10, 10′, 10″).

2. The manufacturing method according to the preceding claim, done by digitally-controlled machining or electro-erosion.

3. A winding (1) comprising at least two interwoven conductive limbs (10, 10′, 10″) each corresponding to a phase of an electric current, each of the limbs (10, 10′, 10″) being rigid and in a single component, the winding being obtained according to the method according to any one of the two preceding claims, each of the limbs (10, 10′, 10″) being formed by slots, each slot comprising an apex (15, 15a, 15b, 15′, 15″) framed by at least one lateral segment (16, 16a, 16b, 16′, 16″) at each of its ends and a base (14, 14′, 14″) connecting the slot to an adjacent slot of the limb (10, 10′, 10″), each lateral segment (16, 16a, 16b, 16′, 16″) connecting an end part of the apex (15, 15a, 15b, 15′, 15″) to an end part of the base (14, 14′, 14″), characterized in that the apices (15, 15a) of the slots of a first limb (10) are at a higher level on the winding (1) than the apices (15′, 15″) of the slots of the second limb (10′, 10″) with a radial angular offset between the slots of one limb (10) relative to the other (10′, 10″), the bases (14) of the slots of the first limb (10) being at a lower level on the winding (1) than that of the bases (14′, 14″) of the slots of the second limb (10′, 10″), all of the slots forming the body of the limb (10, 10′, 10″).

4. The winding (1) according to claim 3, characterized in that it comprises n single-component rigid limbs (10, 10′, 10″), with x greater than 1 and less than n, the apex (15, 15a, 15b, 15′, 15″) of the x^{th} limb (10, 10′, 10″) being at a level higher than that of the apex (15, 15a, 15b, 15′, 15″) of the x+1^{st} limb (10, 10′, 10″) and at a level lower than that of the apex (15, 15a, 15b, 15′, 15″) of the x−1^{st} limb (10, 10′, 10″), the base (14, 14′, 14″) of the x^{th} limb (10, 10′, 10″) being at a lower level than the base (14, 14′, 14″) of the x−1^{st} limb (10, 10′, 10″) and a higher level than the base (14, 14′, 14″) of the x+1^{st} limb (10, 10′, 10″).

5. The winding (1) according to claim 3 or 4, characterized in that each apex (15′, 15″) of said at least one second limb (10′, 10″) or each base (14) of the first limb (10) has a notch (18, 19) for the passage of a lateral segment (16, 16a, 16b, 16c) of a slot of the first limb (10) or, respectively, a lateral segment (16′, 16″) of a slot of said at least one second limb (10′, 10″).

6. The winding (1) according to any one of claims 3 to 5, characterized in that the lateral segments (16, 16a, 16b, 16′, 16″) of the slots of the limbs (10, 10′, 10″) are inclined in the height direction of the winding (1) toward the associated base (14, 14′, 14″) of the slots.

7. The winding (1) according to any one of claims 3 to 5, characterized in that the lateral segments (16, 16a, 16b, 16′, 16″) of the slots of the limbs (10, 10′, 10″) are positioned in the same plane as the associated apex (15, 15a, 15b, 15′, 15″) of the slots, a level difference (20) being provided on each end of the base (14, 14′, 14″) for its connection with the opposite end of the associated lateral segment (16, 16a, 16b, 16′, 16″).

8. The winding (1) according to any one of claims 3 to 7, characterized in that at least for one slot, at least one auxiliary lateral segment (16a, 16b, 16c) is provided connected to the same end of an apex (15, 15a) as a lateral segment (16, 16′, 16″) that is part of the body of the limb (10, 10′, 10″).

9. The winding (1) according to claim 8, characterized in that said at least one auxiliary lateral segment (16a, 16b, 16c) is rigid and form a single component with the body of the limb (10, 10′, 10″) supporting it.

10. The winding (1) according to claim 8, characterized in that said at least one auxiliary lateral segment (16a, 16b, 16c) is connected with its associated apex (15, 15a) by a securing means.

11. The winding (1) according to any one of the three preceding claims, characterized in that the lateral segments (16, 16a, 16b, 16c) associated with a same end have one or more of the following features: different sections, different orientations or different materials.

12. The winding (1) according to any one of claims 3 to 11, characterized in that it is formed from three conductive limbs (10, 10′, 10″) each corresponding to a phase of a three-phase electric current.

13. A permanent-magnet electromagnetic motor or generator (50) comprising at least one rotor (52) and at least one stator (40), characterized in that it comprises at least one winding (1) according to any one of claims 3 to 11.

14. The permanent-magnet electromagnetic motor or generator (50) according to the preceding claim, which is an axial flux electromagnetic motor or generator (50), said at least one winding (1) having a cylindrical shape, or a radial flux electromagnetic motor or generator, said at least one winding (1) being crown-shaped.

15. The motor (50) according to any one of claim 13 or 14, characterized in that its stator(s) (40) comprise a flat ring (30) provided with teeth (31) situated in the plane of the ring (30) facing the associated rotor (52), at least one winding (1) being interleaved in those teeth (31).

16. The motor (50) according to any one of claim 13 or 14, characterized in that said at least one winding (1) is molded in an insulating binder and housed in the stator(s) (40), and in that the rotor(s) (52) has permanent magnets made from glass fiber.

17. A use of a motor or generator according to any one of claims 13 to 16, characterized in that it is done in combination with a closed enclosure, the motor or generator being placed inside or outside said enclosure, the motor or generator being under vacuum or pressure exceeding 2 bars or at a temperature below 0° C. or above 60° C.
